(19) United States
(12) Patent Application Publication
(10) Pub. No.: US 2004/0070566 A1
(43) Pub. Date: Apr. 15, 2004

(54) Card present network transactions

(76) Inventor: Jason A. Ashton, Scotts Valley, CA (US)

Correspondence Address: CARR & FERRELL LLP, 2200 GENG ROAD, PALO ALTO, CA, 94303, US

(21) Appl. No.: 10/442,011

(22) Filed: May 19, 2003

Related U.S. Application Data
(63) Continuation-in-part of application No. 10/264,617, filed on Oct. 3, 2002.

(51) Int. Cl. G09G 5/00; G09G 5/08

(52) U.S. Cl. 345/156; 345/157; 345/163

(57) ABSTRACT

The invention includes systems and methods for executing card present network transactions. Security is achieved using a peripheral device including an electronically stored serial number, a logic circuit, a motion sensor, and a sensor configured to read a portable data repository such as a credit card. The peripheral is configured to perform functions of a pointing device, such as a mouse or trackball. Several methods are disclose in which aspects of the invention are used to perform card present purchases of products or services over a computer network, such as the Internet.

In another aspect of the invention the peripheral device and the portable data repository are used to control output of a device identification.

This application is a continuation-in-part of commonly owned U.S. patent application Ser. No. 10/264,617 entitled “Secure Input Device,” filed Oct. 3, 2002, and which is incorporated herein as Appendix I.

### BACKGROUND

1. Field of the Invention

The invention is in the field of computer security and more specifically in the field of secure transactions on computer networks.

2. Description of the Prior Art

Computer networks, such as the internet, are frequently used to perform financial transactions. However, the security of data included in these transactions is of concern. Security breaches have been known to occur at any party involved in a transaction or while data is transferred over the computer network.

One difference between a financial transaction that takes place over a computer network and a financial transaction that takes place between parties face-to-face is that the parties in the face-to-face transaction can be more certain of each other's identity. For example, in a typical point of sale (POS) transaction, a purchaser offers a credit card and possibly some additional identification to a merchant. The merchant can confirm that the purchaser is in actual possession of the credit card and can confirm the purchaser's identity using the other identification. In addition, in this type of transaction, the merchant can require affirmative indication, such as a signature, that the purchaser acknowledges the transaction and agrees to pay the resulting bill.

The purchaser in a face-to-face transaction is also able to more thoroughly establish the identity of a merchant receiving the credit card. In contrast, over a computer network, data sent to a merchant may be intercepted or a third party may fool the purchaser into thinking that they are the merchant. These breaches of security are much more difficult when the purchaser can actually see the physical presence of the merchant.

Breaches in the security of transactions performed over a computer network can result in considerable expense. There is, therefore, need for systems and methods that improve the security of these transactions.

### SUMMARY OF THE INVENTION

Various embodiments of the invention include a consumer terminal comprising a reader including a) a multi-bit data sensor configured to read non-encrypted transaction data from a portable data repository, b) a serial number configured to identity the reader, and c) a logic circuit configured to generated encrypted transaction data using the non-encrypted transaction data, the consumer terminal further comprising a communication interface configured to transmit the encrypted transaction data through a network, a processor configured to control the communication interface and to manage data received from the reader, the data received from the reader including the serial number, the encrypted transaction data, and the output responsive to the movement detector.

Various embodiments of the invention include transaction system comprising a communication interface configured to receive encrypted transaction data through a network, the transaction data encrypted using a reader including a multi-bit data sensor configured to read non-encrypted transaction data from a portable data repository, and a logic circuit configured to generated the encrypted transaction data from the non-encrypted transaction data, memory configured to store a decryption key configured for decrypting the encrypted transaction data, and a server configured to decrypt the encrypted transaction data using the encryption key

Various embodiment of the invention include a method of performing a transaction, the method comprising receiving a request for the transaction at a network client reading transaction data from a portable data repository using a reader, the reader including a multi-bit data sensor configured to read the transaction data from a portable data repository, and a logic circuit configured to modify the transaction data, modifying all or part of the transaction data, transmitting the modified transaction data from the network client to a merchant system, transmitting the modified transaction data from the merchant system to a banking system, verifying the transaction data using the banking system and consumer data stored therein, and transmitting the verification from the banking system to the merchant system.

Various embodiments of the invention include a method of performing a transaction, the method comprising receiving a request for the transaction at a consumer terminal, the transaction including a transaction value, reading transaction data from a portable data repository using a reader, the reader including a multi-bit data sensor configured to read the transaction data from a portable data repository, transmitting the transaction data from the consumer terminal to a banking system, the banking system including a transaction system, verifying the transaction data using the transaction system and consumer data stored therein, generating a transaction code responsive to a result of the verification, storing a copy of the transaction code in the transaction system, transmitting the transaction code from the banking system to the consumer terminal, transmitting the transaction code from the consumer terminal to a merchant system, transmitting the transaction code from the merchant system to the banking system, verifying the transaction using the transaction system, the transaction code received from the merchant system and the stored copy of the transaction code, and transmitting the verification from the banking system to the merchant system.

Various embodiments of the invention include a method of performing a transaction, the method comprising receiving a request for the transaction at a network client, the transaction including a transaction value, reading transaction data from a portable data repository using a reader, the reader including a multi-bit data sensor configured to read the transaction data from a portable data repository, and a logic circuit configured to encrypt the transaction data, generating a transaction code using the logic circuit, encrypting the transaction data, transmitting the encrypted transaction data and the transaction code from the network client to a banking system, the banking system including a transaction system, decrypting the encrypted transaction data using the transaction system, verifying the decrypted transaction data using the transaction system and consumer data stored therein, storing a copy of the transaction code and a verification result in the transaction system, transmitting the transaction code from the network client to a merchant system, transmitting the transaction code from the merchant system to the banking system, retrieving the stored verification result from the transaction system using the transaction code received from the merchant system, and transmitting the verification result from the banking system to the merchant system.

Various embodiments of the invention include a method of performing a transaction, the method comprising receiving a request for the transaction at a network client, the transaction including a transaction value and an order number, reading transaction data from a portable data repository using a reader, the reader including a multi-bit data sensor configured to read the transaction data from a portable data repository, and a logic circuit configured to encrypt the transaction data, encrypting the transaction data using the logic circuit, transmitting the encrypted transaction data and the order number from the network client to a banking system, the banking system including a transaction system, decrypting the encrypted transaction information using the transaction system and reader data stored therein, verifying the decrypted transaction data using the transaction system and consumer data stored therein, storing a copy of the order number and a verification result in the transaction system, transmitting the order number from the network client to a merchant system, transmitting the order number from the merchant system to the banking system, retrieving the stored verification result from the card present transaction system using the order number received from the merchant system, and transmitting the verification result from the banking system to the merchant system.

Various embodiments of the invention include a method of purchasing a product or service over a computer network, the method comprising selecting a product or service offered by a merchant, reading data from a portable data repository using a reader, automatically populating data fields responsive to the read data, and automatically communicating the populated data fields to the merchant to execute a secure transaction.

Various embodiments of the invention include a method of controlling access to a device identity, the method comprising, receiving a request for a device identity, deciding to accept the request, reading a portable data repository using a reader, the reader including a) a multi-bit data sensor configured to read data from the portable data repository, b) reader data stored in memory, and c) a logic circuit configured to authorize output of a device identity, the authorization being responsive to a comparison of the reader data and the data read from the portable data repository, authorizing output of the device identity using the logic circuit, and outputting the device identity responsive to the authorization.

Various embodiments of the invention include a system for performing a network transaction, the system including a pointing device configured to read a credit card, a smart card or a debit card, a network client configured to receive data from the pointing device and to transmit the received data to a card present transaction system, and means for making the network transaction a card present transaction.

Various embodiments of the invention include a consumer terminal comprising a reader including a user interface configured for manual entry of non-encrypted transaction data, a logic circuit configured to generate encrypted transaction data using the non-encrypted transaction data, and a peripheral interface configured to transfer the encrypted transaction data from the reader. The consumer terminal further including a network client configured to receive the encrypted transaction data transferred from the reader, the client including a communication interface configured to transmit the encrypted transaction data through a network, and a processor configured to control the communication interface and to manage data received from the reader, the data received from the reader including the encrypted transaction data.

Various embodiments of the invention include a method of performing a transaction, the method comprising receiving a request for the transaction at a network client, receiving transaction data using a reader, the reader including a user interface configured to receive transaction data from a user, and a peripheral interface configured to transfer the transaction data from the reader, modifying all or part of the transaction data, transmitting the modified transaction data from the network client to a merchant system, the merchant system not having access to all or part of the unmodified transaction data, transmitting the modified transaction data from the merchant system to a banking system, verifying the transaction data using the banking system and consumer data stored therein, and transmitting the verification from the banking system to the merchant system.

Various embodiments of the invention include a method of performing a transaction, the method comprising receiving transaction data from a user, transmitting the transaction data from the consumer terminal to a banking system, the banking system including a transaction system, verifying the transaction data using the transaction system and consumer data stored therein, generating a transaction code responsive to a result of the verification, storing a copy of the transaction code in the transaction system, transmitting the transaction code from the banking system to the consumer terminal, transmitting the transaction code from the consumer terminal to a merchant system, transmitting the transaction code from the merchant system to the banking system, verifying the transaction using the transaction system, the transaction code received from the merchant system and the stored copy of the transaction code, and transmitting the verification from the banking system to the merchant system.

Various embodiments of the invention include a method of performing a transaction, the method comprising receiving transaction data from a user, using a reader including a user interface, generating a transaction code using a logic circuit, encrypting the transaction data using the logic circuit, transmitting the encrypted transaction data and the transaction code from the network client to a banking system, the banking system including a transaction system, decrypting the encrypted transaction data using the transaction system, verifying the decrypted transaction data using the transaction system and consumer data stored therein, storing a copy of the transaction code and a verification result in the transaction system, transmitting the transaction code from the network client to a merchant system, transmitting the transaction code from the merchant system to the banking system, retrieving the stored verification result from the transaction system using the transaction code received from the merchant system, and transmitting the verification result from the banking system to the merchant system.

Various embodiments of the invention include a transaction system comprising a communication interface configured to receive encrypted transaction data through a network, the transaction data encrypted using a reader including a multi-bit data sensor configured to read non-encrypted transaction data from a portable data repository, and a logic circuit configured to generated the encrypted transaction data from the non-encrypted transaction data, memory configured to store a decryption key configured for decrypting the encrypted transaction data, and a server configured to decrypt the encrypted transaction data using the encryption key.

Various embodiments of the invention include a manual data input device comprising a keypad configured for manual entry of non-encrypted data, a serial number stored in memory and configured to identity the data input device, a logic circuit configured to generate encrypted data using the non-encrypted data, and a peripheral interface configured for communicating the encrypted data or the serial number, to a computing device. In some of these embodiments, the manual data input device further including an input configured to turn on or off the encryption of data using the logic circuit.

Various embodiments of the invention include a method of performing a transaction, the method comprising receiving a request for the transaction at a consumer terminal, the transaction including a transaction value, reading transaction data from a portable data repository using a reader, the reader including a multi-bit data sensor configured to read the transaction data from a portable data repository, transmitting the transaction data from the consumer terminal to a banking system, the banking system including a transaction system, verifying the transaction data using the transaction system and consumer data stored therein, generating a transaction code responsive to a result of the verification, storing a copy of the transaction code in the transaction system, transmitting the transaction code from the banking system to the consumer terminal, transmitting the transaction code from the consumer terminal to a merchant system, transmitting the transaction code from the merchant system to the banking system, verifying the transaction using the transaction system, the transaction code received from the merchant system and the stored copy of the transaction code, and transmitting the verification from the banking system to the merchant system.

Various embodiments of the invention include a method of purchasing a product or service over a computer network, the method comprising, selecting a product or service offered by a merchant, reading data from a portable data repository using a reader, automatically populating a data field with data, responsive to the read data, and communicating the data populated, over the computer network to execute a secure transaction. In some of these embodiments the data populated is communicated to a merchant or a banking system. In some of these embodiments, the data populated includes an e-mail address. In some of these embodiments, the read data includes an e-mail address. In some of these embodiments the data populated includes at least part of the data read from the portable data repository. In some of these embodiments the communication of the data populated over the computer network is automatic.

Various embodiments of the invention include a method of performing a transaction, the method comprising receiving a request for the transaction at a network client, receiving transaction data using a reader, the reader including, a user interface configured to receive transaction data from a user, and a peripheral interface configured to transfer the transaction data from the reader, modifying all or part of the transaction data, transmitting the modified transaction data from the network client to a merchant system, the merchant system not having access to all or part of the unmodified transaction data, transmitting the modified transaction data from the merchant system to a banking system, verifying the transaction data using the banking system and consumer data stored therein, and transmitting the verification from the banking system to the merchant system.

Various embodiments of the invention include a system for performing a network transaction, the system including a pointing device configured to read a credit card, a smart card or a debit card, a network client configured to receive data from the pointing device and to transmit the received data to a card present transaction system, and means for making the network transaction a card present transaction.

Various embodiments of the invention include a portable data repository including memory configured to store user data, the user data configured for use in delivering a product or service to a user, the memory being configured to be read using a transaction system, the transaction system being configured for transmission of the user data to a merchant system for delivery, using the user data, of the product or service to the user. This user data can be a shipping address, e-mail address, network address, or the like.

### BRIEF DESCRIPTION OF THE VARIOUS VIEWS OF THE DRAWINGS

FIG. 1 is a block diagram illustrating relationships between parties of a card present transaction over a computer network;

FIG. 2 is a block diagram illustrating details of a consumer terminal according to various embodiments of the invention;

FIG. 3 is a block diagram illustrating a card present transaction system according to various embodiments of the invention;

FIG. 4 is a flowchart illustrating a method of performing a card present transaction according to various embodiments of the invention;

FIG. 5 is a flowchart illustrating an alternate method of performing a card present transaction according to various embodiments of the invention

FIG. 6 is a flowchart illustrating a method of performing a card present transaction according to various embodiments of the invention;

FIG. 7 is a flowchart illustrating a method of purchasing a product or service over a computer network according to various embodiments of the invention; and

FIG. 8 is a flowchart illustrating a method of controlling access to a device identity.

### DISCLOSURE OF THE INVENTION

Embodiments of the invention include systems and methods of performing a card present transaction over a computer network, such as the Internet. A card present transaction is one in which a payee can require that a payer be in actual possession of a credit card or other data repository. In addition, embodiments of the invention include systems and methods of enhancing the security of transaction data, such as a credit card number (e.g., account number), used in a transaction. This protection is achieved through encryption or other modification of the transaction data. Transactions within the scope of the invention optionally make use of a consumer terminal configured to read a credit card or similar data storage device. In some embodiments, this consumer terminal is also configured to encrypt and/or add security codes to the transaction data.

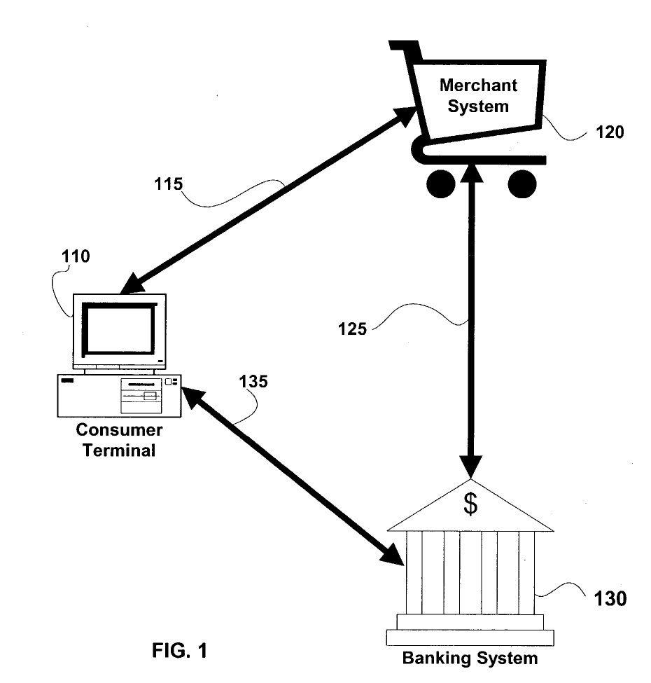

FIG. 1 is a block diagram illustrating relationships between parties of a card present transaction over a computer network. Consumer Terminal 110 is a computing device used by one party in the transaction (e.g., a purchaser or consumer) to engage in the transaction. In various embodiments, Consumer Terminal 110 is a computing device such as a personal computer, network terminal, personal digital assistant, telephone, or the like. Consumer Terminal 110 is configured to communicate with a Merchant System 120 through,a Consumer-Merchant Channel 115. This channel may include a computer network, such as a local area network, a wide area network, a telephone network, a wireless network, the Internet, or the like. In some embodiments, Consumer-Merchant Channel 115 is facilitated by an Internet browser executing on Consumer Terminal 110.

Merchant System 120 includes the computing system and software of a second party in the transaction (e.g., an online merchant or service provider). Merchant System 120 is configured to communicate with a Banking System 130 through a Merchant-Bank Channel 125. In some embodiments, Merchant-Bank Channel 125 includes a computer network such as a local area network, a wide area network, a telephone network, a wireless network, the Internet, or the like. In some embodiments, Merchant-Bank Channel 125 includes a private direct connection between Merchant System 120 and Banking System 130.

Banking System 130 includes the computing systems and software of one or more additional party in the transaction. For example, in some embodiments, Banking System 130 includes a bank, a credit card company, a data processing company and/or a similar financial institution. In some embodiments, Banking System 130 includes a system configured to receive data from Consumer Terminal 110. Communication between Banking System 130 and Consumer Terminal 110 is accomplished using optional Bank-Consumer Channel 135. Bank-Consumer Channel 135 includes a computer network such as a local area network, a wide area network, a telephone network, a wireless network, the Internet, or the like. For example, in some embodiments, Bank-Consumer Channel includes an Internet connection supported by a browser executing on Consumer Terminal 110. Consumer-Merchant Channel 115, Merchant-Bank Channel 125 and Bank-Consumer Channel 135 optionally share components. For example, in various embodiments communications hardware included in Consumer Terminal 110 is part of both Consumer-Merchant Channel 115 and Bank-Consumer Channel 135.

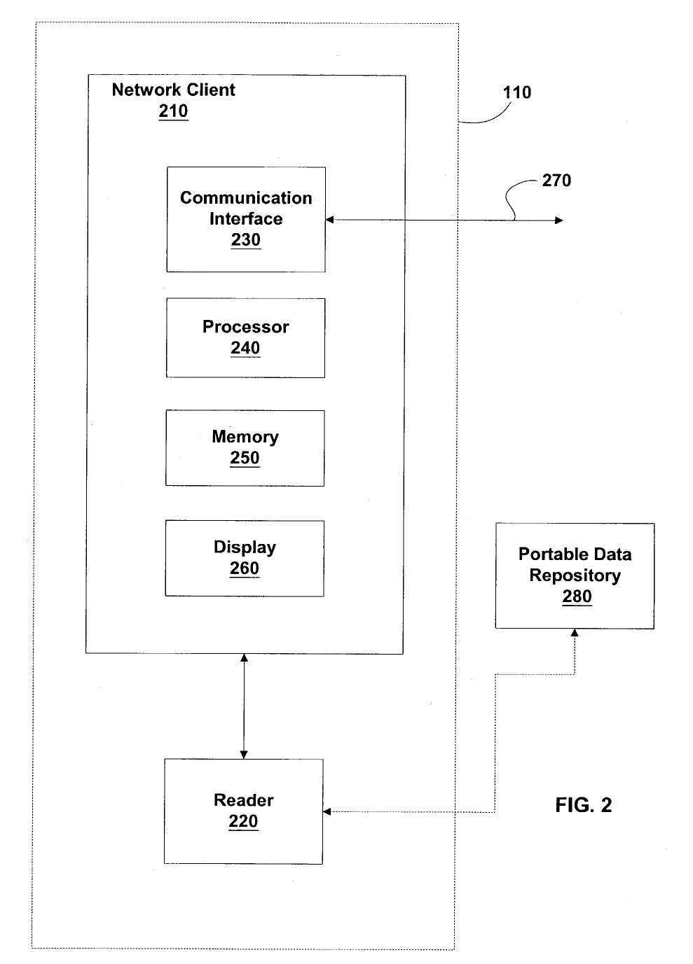

FIG. 2 is a block diagram illustrating further details of Consumer Terminal 110 according to various embodiments of the invention. Consumer Terminal 110 includes a Network Client 210 and a Reader 220. Network Client 210 is a computing device comprising a Communication Interface 230, a Processor 240, a Memory 250 and an optional Display 260. Communication Interface 230 is a communication device, such as an Ethernet port, modem, router, hub, or the like, configured for communicating through Channel 270. Channel 270 is either Consumer-Merchant Channel 115 and/or Bank-Consumer Channel 135. Processor 240 includes an integrated circuit such as a logic circuit or a central processing unit (CPU), and is configured to control access to Memory 250 and optionally to encrypt or modify data received from Reader 220. In some embodiments Reader 220 is a peripheral device, such as a keyboard, monitor, or mouse, including a peripheral interface for communication with Network Client 210. In some embodiments, Reader 220 is integrated within Network Client 210. Memory 250 includes random access memory, electronic, magnetic or optical storage, or the like. Display 260 is optionally configured to support an Internet browser.

Reader 220 is configured to read data from a Portable Data Repository 280 and/or to receive data through manual input (e.g. typing or clicking, etcetera). In some embodiments, Reader 220 is a pointing device as further described in U.S. patent application Ser. No. 10/264,617 filed Oct. 3, 2002. For example in some embodiments, Reader 220 is a pointing device, such as a computer mouse, track ball, joystick, or the like, configured to receive directional input from a user. In these embodiments, Reader 220 includes a movement detector, an optional logic circuit, optional memory, and a multi-bit data sensor configured to read data from Portable Data Repository 280, such as the portable data repository described in U.S. patent application Ser. No. 10/264,617. Portable Data Repository 280 is optionally a credit card, smart card, debit card, phone card, check or the like. In some embodiments, Portable Data Repository 280 is an access card, driver's license or other identity card.

In alternative embodiments, Reader 220 includes a user interface configured for manual entry of transaction data. For example, this user interface is optionally a keyboard, a keypad, a voice-to-text device, a touch sensitive tablet, other computer peripheral or the like, configured to receive data entered by a user. In some embodiments, Reader 220 is a keyboard including electronic memory, a logic circuit, a serial number stored in the memory, and/or a multi-bit data sensor configured to read data from Portable Data Repository 280. In various embodiments, the logic circuit of Reader 220 is optionally configured to encrypt data received through manual entry. In one embodiment, Reader 220 includes an input configured to control the operation of the logic circuit. An example of this embodiment optionally includes a manual switch configured to turn on and off encryption operations within the logic circuit. Another example of this embodiment includes an electronic circuit (switch) configured to turn on and off encryption operations within the logic circuit. In one example of this embodiment, Reader 220 is a computer peripheral, such as a keyboard. The peripheral communicates with and is optionally powered by a peripheral interface configured to communicate encrypted data and/or a serial number to a computing device. In one embodiment, memory configured to store the serial number, the logic circuit and the peripheral interface are all included at least partially within the peripheral. In one embodiment, Reader 220 is a keyboard including a keypad, the logic circuit configured for encrypting keystrokes, and a switch configured to turn on or off encryption operations. In this embodiment, when the switch is on keystrokes are encrypted before being passed out of the peripheral, and when the switch is off keystrokes are passed to a computing device using the peripheral interface without encryption.

As further described in U.S. patent application Ser. No. 10/264,617, the logic circuit of Reader 220 is optionally configured to encrypt data stored in Reader 220, data received from Portable Data Repository 280, data manually entered using Reader 220, or data received by Reader 220 from Network Client 210. In some embodiments, Reader 220 is configured to operate only with one or more specific Portable Data Repository 280. This configuration is optionally established through a registration process.

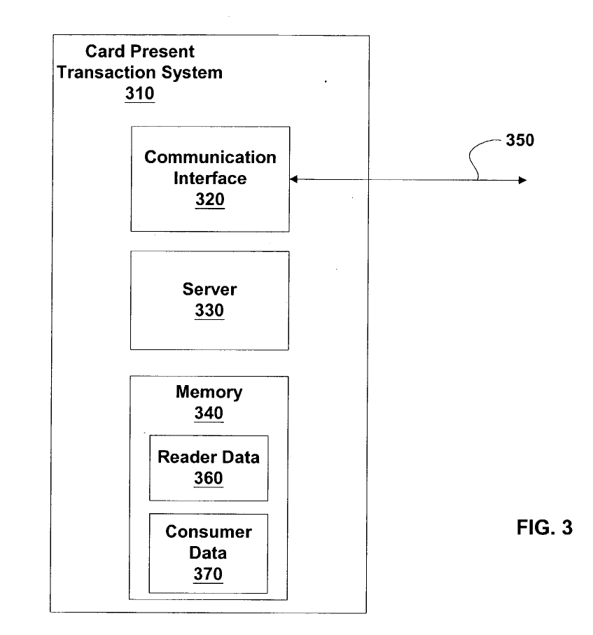

FIG. 3 is a block diagram illustrating a Card Present Transaction System 310 according to various embodiments of the invention. Card Present Transaction System 310 is included in typical embodiments of Banking System 130. In these embodiments, Card Present Transaction System 310 includes a Communication Interface 320, Server 330 and Memory 340. Communication Interface 320 is configured to communicate with Merchant System 120 and/or Consumer Terminal 110 through a Channel 350. Channel 350 is Merchant-Bank Channel 125 and/or Bank-Consumer Channel 135. Server 330 is a computing device configured to support Communication Interface 320 and to access Memory 340. Server 330 optionally includes a database server, file server, network server, Internet server, or the like.

Memory 340 is configured to store Reader Data 360 and/or Consumer Data 370. Reader Data 360 includes data characterizing Reader 220 (FIG. 2), such as a serial number of Reader 220, an identity of a registered user of Reader 220, decryption/encryption keys associated with Reader 220, information about a Portable Data Repository 280 associated with Reader 220 (e.g., one or more credit cards authorized for use with Reader 220), or the like. In some embodiments, Reader Data 360 also includes a log of approved and denied transactions requested using Reader 220, Internet protocol (IP) addresses used in these transactions, or the like.

Consumer Data 370 includes information regarding Portable Data Repository 280 and/or a registered user of Portable Data Repository 280. For example, in some embodiments, Consumer Data 370 includes a serial number of Portable Data Repository 280. In embodiments wherein Portable Data Repository 280 is a credit card, Consumer Data 370 includes a credit card number, expiration date, consumer name, billing address, credit limits, account balances, charge history, allowed shipping addresses, or the like.

In some embodiments, Card Present Transaction System 310 is a distributed computing system including a plurality of Server 330 and/or a plurality of Memory 340. In these embodiments, various aspects of Card Present Transaction System 310 are optionally distributed among various parties. For example, in one embodiment, Reader Data 360 is stored on a separate computing device configured to process data received from Consumer Terminal 110 and controlled by a third party data processing company, such as a data processing company configured to manage credit card transactions on behalf of credit card companies and banks that issue the credit cards. In one embodiment, Consumer Data 370 is stored on a separate computing device controlled by a credit card company.

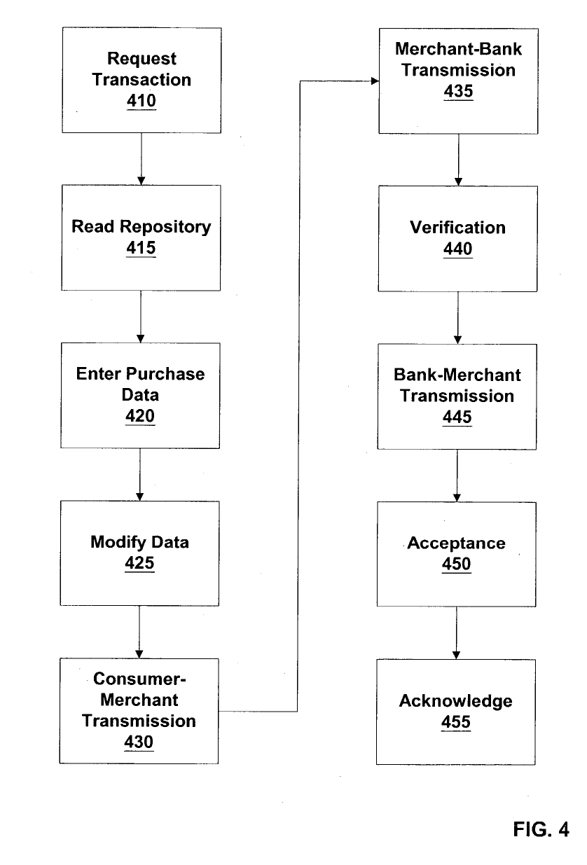

FIGS. 4 through 6 illustrate several different methods of performing a transaction according to embodiments of the invention. In some embodiments, Reader 220 is used to establish that a user is in actual possession of Portable Data Repository 280. In some embodiments, a logic circuit in Network Client 210 and/or Reader 220 is used to encrypt or otherwise modify transaction data and thus enhance security of this data.

FIG. 4 is a flowchart illustrating a method of performing a card present transaction according to various embodiments of the invention. In these embodiments, Reader 220 is used to provide information establishing that a consumer is in possession of Portable Data Repository 280 (e.g., a credit card). In these embodiments, part of the transaction data used to facilitate a transaction is modified through encryption or substitution. Modification of the transaction data reduces the possibility that it will be subject to a subsequent security breach. In the embodiments illustrated by FIG. 4, encryption or substitution of the transaction data is optionally also used to establish that Portable Data Repository 280 has been read using Reader 220. This establishes that this is a card present transaction by ensuring that the user is in actual possession of Portable Data Repository 280.

In a Request Transaction Step 410, Consumer Terminal 110 receives a request for a transaction, such as a credit card payment. In some embodiments, this request is received from a consumer using Consumer Terminal 110, while in other embodiments, this request is received in the form of a demand for payment from a merchant. This request is optionally supported using a browser and Internet protocols. For example, in some embodiments, Request Transaction Step 410 includes accessing an online shopping cart including products or services to be purchased. Completion of the purchase includes a request from a merchant for a credit card payment.

In some embodiments, in a Read Repository Step 415, Portable Data Repository 280 is read using Reader 220. As further disclosed in U.S. patent application Ser. No. 10/264,617, reading data from Portable Data Repository 280 optionally includes electronic, electro/magnetic, optical, or wireless communication, or the like. In some embodiments, Portable Data Repository 280 is a card including a magnetic strip and reading occurs when Portable Data Repository 280 is “swiped” through Reader 220.

In alternative embodiments, Read Repository Step 415 is replaced by a manual entry step (not shown). In the manual entry step, Reader 220 is used to manually enter data, such as the types of data that could be stored in Portable Data Repository 280. In one embodiment, the manual entry step includes activating an input included in Reader 220 and configured to turn on and off encryption of keystrokes using the logic circuit of Reader 220.

The information received in Read Repository Step 415 optionally includes transaction data configured for performing a payment, such as credit card data, a shipping address, a driver's license number, a social security number or the like. Credit card data typically includes a sixteen digit card number, a three digit credit card confirmation number, an expiration date, and a user name. In some embodiments, credit card data also includes a billing address, a personal identification number, or the like. In alternative embodiments, credit card data is replaced by other types of transaction data. For example, credit card data is optionally replaced by debit card data, bank account data, debit account data, credit line data, or the like.

In an optional Enter Purchase Data Step 420, any further data required for execution of the transaction is entered by a user using Network Client 210. This data may include, for example, the consumer's name, card number, social security number, identification number, billing address, shipping address, sixteen digit credit card number, three digit credit card confirmation number, credit card expiration date, personal identification number, shipping address, or the like. In some embodiments, this data is entered using a form, optionally displayed using a browser. In one embodiment, data read in Read Repository Step 415 is used to pre-populate this form. Enter Purchase Data Step 420 is optional if all data required to execute the transaction is available following Read Repository Step 415.

In some embodiments of a Modify Data Step 425, data read in Read Repository Step 415, data entered manually in place of Read Repository Step 415, and/or data entered in Enter Purchase Data Step 420 is modified using a logic circuit included in Reader 220. In alternative embodiments of Modify Data Step 425, modification is accomplished using Processor 240 (FIG. 2). This modification optionally includes encryption or substitution of all or part of these data. For example, in various embodiments, modified data includes various combinations of four digits of the credit card number, an expiration data of a credit card, part of the billing address, or the like. In some embodiments, the encrypted data is configured to have a data size (e.g., number of bits) that is the same as its non-encrypted form. In some embodiments, a serial number of Reader 220, or Processor 240, or some other hardware identifying information, is incorporated into the encrypted data or substituted for the data read in Read Repository Step 425 or entered in Enter Purchase Data Step 420.

Substitution includes replacement of transaction data with data derived from another source. For example, in one embodiment part of a billing address is replaced by a character string derived from a serial number of Reader 220 and/or Processor 240. In another example, a street name and number of a billing address is encrypted in Modify Data Step 425. In this embodiment, the encrypted copy of the street address and, optionally, an encrypted copy of the serial number are sent to Merchant System 120 in place of the non-encrypted copy of the billing address. In alternative embodiments, copies of the expiration data, or three digit credit card extension, etcetera, rather than part of the billing address, are encrypted, substituted and sent.

In a Consumer-Merchant Transmission Step 430, data required to execute the transaction are transferred, using Channel 115 from Consumer Terminal 110 to Merchant System 120. These data include data modified in Modify Data Step 425. In Consumer-Merchant Transmission Step 430, the merchant typically does not receive an unencrypted copy of all of the transaction data required to perform the transaction. At least part of the data is, therefore, protected from security breaches occurring at the merchant or during the transmission. In one embodiment, the merchant only receives information required to ship a requested product to the consumer and to collect funds from a payee such as a credit card company or bank. In one embodiment, the data received by Merchant System 120 in Consumer-Merchant Transmission Step 430 includes an Internet Protocol Address associated with Consumer Terminal 110.

In some embodiments, the encrypted data is configured such that it can be processed by Merchant System 120 in the same manner as an unencrypted copy would be processed. For example, in one embodiment the first line of a billing address is treated as a string of 64 characters or less. In Consumer-Merchant Transmission Step 430 this first line is replaced by an encrypted string of the same number of characters. As discussed further below this data typically remains encrypted until received by Banking System 130.

In a Merchant-Bank Transmission Step 435 data required to authorize payment for the transaction are transmitted from Merchant System 120 to Banking System 130 using Channel 125. Typically, the data is received using Communication Interface 320.

In a Verification Step 440 data encrypted in Modify Data Step 425, and received by Banking System 10 in Merchant-Bank Transmission Step 435, is decrypted using Server 330. The received data is compared with Consumer Data 370 and optionally with Reader Data 360 to establish the identity of the consumer and of Reader 220, respectively. In some embodiments, a certain Reader 220 is only registered for use with one or more specific Portable Data Repository 280. In some embodiments, a certain Portable Data Repository 280 is only registered for use with one or more Reader 220. Verification Step 440 also typically includes authorization to execute the transaction based on the credit card's current account balance, credit limit, payment history, etcetera.

If the comparisons of Verification Step 440 confirm proper identities and authorizations, an authorization notice is provided to Merchant System 120 in a Bank-Merchant Transmission Step 445. This authorization notice may include for example, a charge authorization code.

In an optional Acceptance Step 450 the Merchant System 120 accepts the credit card as payment in a transaction. This acceptance is optionally acknowledged to the consumer in an optional Acknowledge Step 455. In some embodiments, Acknowledge Step 455 includes a communication from Merchant System 120 to Consumer Terminal 110. In alternative embodiments, Acknowledge Step 455 includes a communication from Banking System 130 to Consumer Terminal 110. For example, in these alternative embodiments, Banking System 130 may notify Consumer Terminal 110 via e-mail that an order has been excepted by Merchant System 120. In this example, Consumer Terminal 110 optionally receives an e-mail confirmation of an order without necessarily providing Merchant System 120 with an e-mail address. This provides additional privacy to Consumer Terminal 110.

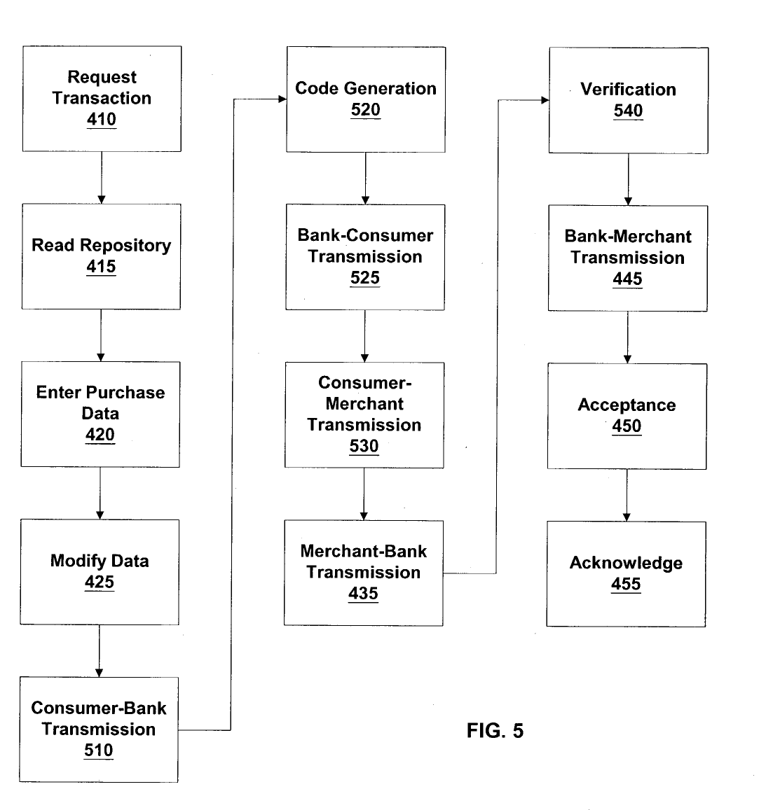

FIG. 5 is a flowchart illustrating an alternate method of performing a transaction according to various embodiments of the invention. In this method, Consumer Terminal 110 and Banking System 130 are used to generate a transaction code configured for use as a temporary credit card number, temporary debit card number, temporary bank account number, or the like. For example, in some embodiments, the transaction code is a temporary credit card code that is transmitted from Consumer Terminal 110 to Merchant System 120 to execute a transaction. In these embodiments, use of a credit card code protects the credit card number from security breaches that may occur at Merchant System 120 or during transmission through Channels 115 and 125. In some embodiments of this method, Reader 220 is used to establish a card present transaction by requiring that a Portable Data Repository 280 be read. In other embodiments, Read Repository Step 415 is optional. In these embodiments, the method illustrated in FIG. 5 does not include a card present transaction. In some embodiments of this method, Reader 220 is used to further enhance security by encrypting the credit card number.

Steps 410 through 425 are performed as discussed with reference to FIG. 4. Step 425 is optional in some embodiments of the method illustrated by FIG. 5. In a Consumer-Bank Transmission Step 510, data read in Read Repository Step 420 and/or entered in Enter Purchase Data Step 420, and optionally modified in Modify Data Step 425, is transmitted from Consumer Terminal 110 to Banking System 130 using Channel 135. In some embodiments, the transmitted data includes a serial number of Reader 220 and/or Processor 240.

Steps 410 through 510 may be better understood through the following illustrative embodiment. Portable Data Repository 280 (e.g., a credit card) is read using Reader 220 (e.g., a pointing device including a multi-bit data sensor) in Read Repository Step 415. In this step, the read credit card information is stored in Reader 220. The consumer then enters his name, preferred shipping address, personal identification number, or the like, in Enter Purchase Data Step 420. In Modify Data Step 425 the credit card information, the purchaser's name, and the personal identification number are optionally encrypted along with a serial number of Reader 220. In some embodiments, this encryption occurs before the serial number and credit card information leave Reader 220. In Consumer-Bank Transmission Step 510 the encrypted data are transferred to Banking System 130.

In a Code Generation Step 520, the data transferred in Consumer-Bank Transmission Step 510 is decrypted if needed and compared with Consumer Data 370 and/or Reader Data 360 to confirm authorization of the transaction. A temporary credit card code is then generated using Card Present Transaction System 310. This temporary credit card code is configured for one use, a limited number of uses, or for use during a limited period of time. A temporary credit card code is optionally associated with a specific limit on the value of transactions for which it may be used. Data associating the temporary credit card code with the actual credit card number is stored in Memory 340. Because the optional encryption of the serial number and credit card information can occur before these data leave Reader 220, and are only decrypted using Card Present Transaction System 310, these data are not available to other parties or systems in an un-encrypted form. In some embodiments an unencrypted copy of the credit card number is not transferred through Network Client and/or transferred to Merchant System 120.

In a Bank-Consumer Transmission 525 the temporary credit card code generated in Code Generation Step 520 is transmitted from Banking System 130 to Consumer Terminal 110 using Channel 135.

In a Consumer-Merchant Transmission 530 data needed to perform the transaction is transferred from Consumer Terminal 110 to Merchant System 120. In this transfer, the temporary credit card code is substituted for an actual credit card number and optionally a credit card expiration date. In some embodiments, the temporary credit card code is configured such that Merchant System 120 cannot distinguish it from the actual credit card number. Merchant-Bank Transmission Step 435 is performed as describe in relation to FIG. 4.

A Verification Step 540 is similar to Verification Step 440 (FIG. 4) except that verification is performed using the temporary credit card code and the data associating the temporary credit card code with the actual credit card number. In some embodiments, Verification Step 540 is responsive to the number of times a request to verify temporary credit card code have been made. For example, in some embodiments an instance of temporary credit card code will only be affirmatively verified once and/or during a limited time period. In some embodiments, Verification Step 540 is responsive to a transaction value limit associated with the temporary credit card code.

Steps 445 through 455 are performed as describe in relation to FIG. 4.

In alternative embodiments, the methods illustrated by FIG. 5 include the use of other transaction data such as debit card data, bank account data, or the like. These transaction data are used in place of, or in addition to, credit card data to generate a debit card code, bank account code, etcetera, that are used in place of a credit card code.

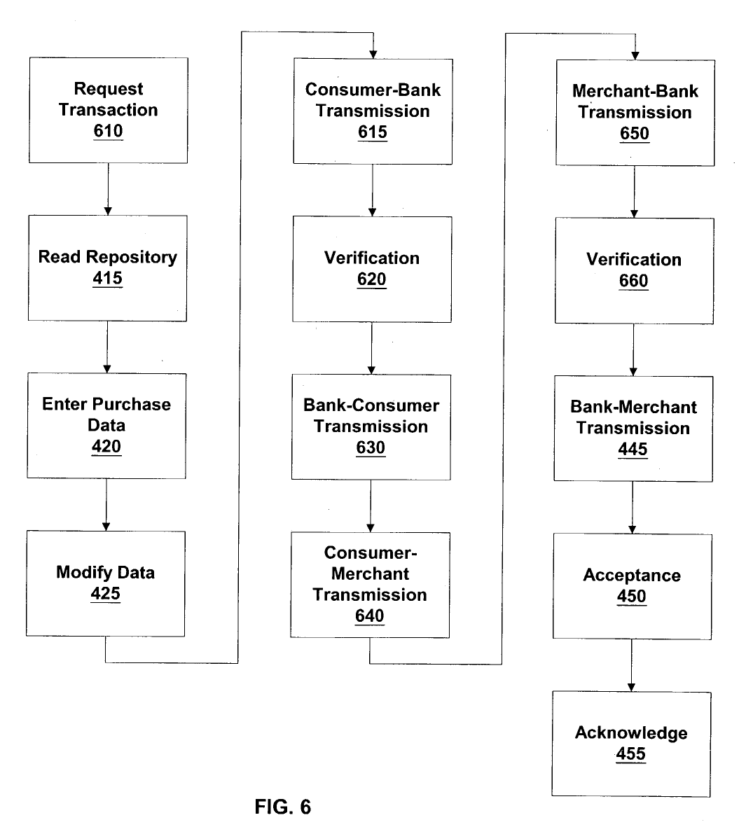

FIG. 6 is a flowchart illustrating a method of performing a card present transaction according to various embodiments of the invention. In this method, a unique order number, a charge value (e.g., a dollar amount), and transaction data (e.g., credit card information) are transmitted from Consumer Terminal 110 to Banking System 130. Banking System 130 verifies the charge and stores the unique order number. At least the order number, the charge value, a shipping address and a name are sent to Merchant System 120. Merchant System 120 transmits the order number to Banking System 130 wherein the order number is compared with that received from Consumer Terminal 110. If the order numbers and charge value agree the charge is authorized.

In further detail, referring to FIG. 6, Steps 410 through 425 are executed as discussed in reference to FIG. 4. In some embodiments Request Transaction 410 includes receiving the order number from Merchant System 120. In other embodiments Read Repository Step 415 includes generation of the order number using Reader 220. In a Consumer-Bank Transmission Step 610, the value of the transaction, the order number, and transaction data are transferred from Consumer Terminal 110 to Banking System 130 using Channel 135. In some embodiments the transferred data also includes an identity of a merchant controlling Merchant System 120, an IP address of Consumer Terminal 110 and/or a serial number of Reader 220.

In a Verification Step 620, Card Present Transaction System 310 is used to approve the transaction and to store the order number. Approval is achieved by comparing the received data with Consumer Data 370 and optionally Reader Data 360. In this step the order number and verification status are saved using Memory 340. In an optional Bank-Consumer Transmission Step 630 the verification status is transmitted to Consumer Terminal 110.

In a Consumer-Merchant Transmission Step 640, order number, the charge value, a shipping address and a name are sent to Merchant System 120 from Consumer Terminal 110 using Channel 115. This transmission to Merchant System 120 does not require any credit card information such as a card number or billing address. In a Merchant-Bank Transmission Step 650, the order number and charge value are transmitted from Merchant System 120 to Banking System 130 using Channel 125. In a Verification Step 660, the order number and charge value received from Merchant System 120 are compared with the order number and charge value received from Consumer Terminal 110 in Consumer-Bank Transmission Step 615. If these data correspond and the charge was authorized in Verification Step 620, then an authorization is generated by Card Present Transaction System 310. This authorization is transferred to Merchant System 120 in Bank-Merchant Transmission Step 445. Steps 450 and 455 are performed as describe in reference to FIG. 4.

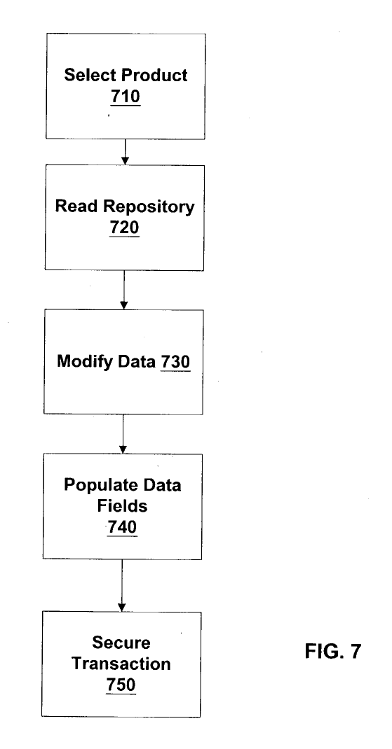

FIG. 7 is a flowchart illustrating a method of purchasing a product or service over a computer network according to various embodiments of the invention. In this method, Portable Data Repository 280 and Reader 220 are used to execute a transaction with minimal further input from a user. In a Select Product Step 710 a product or service to be purchased is selected. In various embodiments selection takes place by viewing a product description web page or an internet shopping cart using a browser. In some embodiments the browser is used to display a “1-swipe” symbol configured to indicate that the displayed product is optionally purchased by reading Portable Data Repository 280 using Reader 220.

In a Read Repository Step 720, data is read from Portable Data Repository 280 using Reader 220. This data optionally includes, for example, a consumer's name, a credit card number, a shipping address, a billing address, or the like. In an optional Modify Data Step 730, the logic circuit in Reader 220 is used to encrypt some or all of the data read in Read Repository Step 720, prior to transfer from Reader 220 to Network Client 210.

In a Populate Data Fields Step 740, data read in Read Repository Step 720, and optionally encrypted, is used to populate data fields. For example, in one embodiment, the data is used to automatically fill a web based form. In another embodiment the data is placed in a metadata compatible format suitable for transmission to Merchant System 120 or Banking System 130. In a typical embodiment, Populate Data Fields Step 740 is automatic and thus does not require further consumer input.

In a Secure Transaction Step 750, a secure transaction (e.g., a card present transaction) is initiated using the data read in Read Repository Step 720. This secure transaction is optionally performed using the methods illustrated in FIGS. 4, 5 and 6. For example, in various embodiments the method illustrated in FIG. 7 proceeds to Steps 430, 510, or 610 of FIGS. 4, 5 and 6, respectively. Secure Transaction Step 750 is optionally automatic.

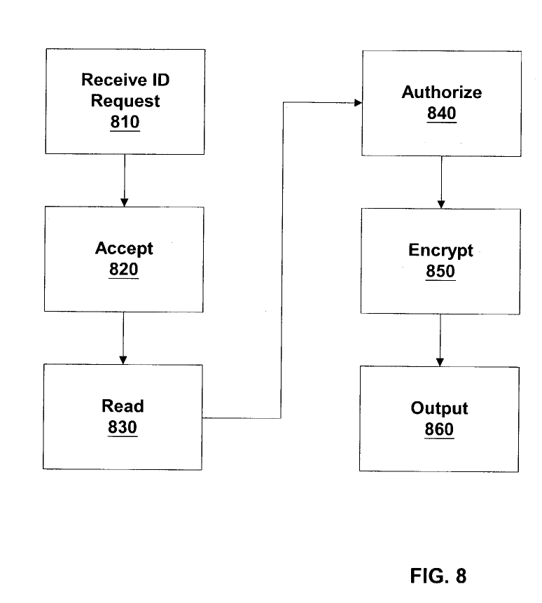

FIG. 8 is a flowchart illustrating a method of controlling access to a device identity. In this method, Reader 220 and Portable Data Repository 280 are used in combination to regulate access to a hardware identification, such as a serial number of Reader 220, an identification number of Processor 240, a media access control layer address of an Ethernet port, or the like. Portable Data Repository 280 and Reader 220 operate as an access key and lock, respectively.

In a Receive ID Request Step 810, a request for identification is received. In various embodiment this request is received from a software application executed on Network Client 210 or on a remote system connected to Network Client 210 via Channel 270.

In an Accept Step 820, a user chooses to accept or deny the request received in Receive ID Request Step 810. If the request is accepted, then Reader 220 is used to read data from Portable Data Repository 280, in a Read Step 830. This step requires that a user physically place Portable Data Repository 280 in a reading location near or in Reader 220. For example, in one embodiment Read Step 830 includes swiping a card (e.g., credit card, driver's license, identification card, smart card, access card, or the like) through a slot in Reader 220.

In an Authorize Step 840, a logic circuit in Reader 220 is used to authorize release of a hardware identification. Typically, authorization is dependent on a comparison between the data read from Portable Data Repository 280 and data previously stored in Reader 220. Further steps are not performed if authorization is not successful.

In an optional Encrypt Step 850, the logic circuit within Reader 220 is used to encrypt a hardware identification. In various embodiment, the hardware identification encrypted is a serial number of Reader 220, an identification number of Processor 240, a media access control layer address of an Ethernet port, or the like. When the hardware identification is a serial number of Reader 220, encryption typically occurs before the serial number is transferred from Reader 220 to Network Client 210 in an Output Step 860. In Output Step 860, the hardware identification is released to the requester that requested the hardware identification in Receive ID Request Step 810. If optional Encrypt Step 850 has been performed, then the hardware identification is released in an encrypted format.

Several embodiments are specifically illustrated and/or described herein. However, it will be appreciated that modifications and variations are covered by the above teachings and within the scope of the appended claims without departing from the spirit and intended scope thereof. For example, in some embodiments Banking System 130 is comprised of several independent parties such as a bank, a credit card company, an intermediary providing authorization services and/or temporary credit card numbers, or the like. Further, transaction data may include alternative methods of payment or financial exchange. For example, In various embodiments of the invention transaction data includes credit card data, debit card data, bank account data, or the like. Likewise, in various embodiments a transaction code includes a credit card code, debit card code, bank account code, or the like. For example, in some embodiments Portable Data Repository 280 includes memory configured to store user data configured for use in delivering a product or service to a user. This user data optionally includes an e-mail address, a shipping address, a network address, or the like. In these embodiments, the memory is configured to be read using Consumer Terminal 110, configured for transmission of the user data to Merchant System 120. Merchant System 120 can then use the user data to deliver a product or service to the user. In one embodiment, the user data is automatically delivered to Merchant System 120 after Portable Data Repository 280 is read using Consumer Terminal 110.

I Claim:

1. A consumer terminal comprising:
a reader including
a user interface configured for manual entry of non-encrypted transaction data,
a logic circuit configured to generate encrypted transaction data using the non-encrypted transaction data, and
a peripheral interface configured to transfer the encrypted transaction data from the reader; and
a network client configured to receive the encrypted transaction data transferred from the reader, the client including
a communication interface configured to transmit the encrypted transaction data through a network; and
a processor configured to control the communication interface and to manage data received from the reader, the data received from the reader including the encrypted transaction data.

2. The consumer terminal of claim 1, wherein the reader further includes a serial number configured to identity the reader.

3. The consumer terminal of claim 1, wherein the reader further includes an input configured to turn on or off the encryption of transaction data using the logic circuit.

4. The consumer terminal of claim 1, wherein the transaction data is credit card data, debit card data or account data.

5. The consumer terminal of claim 1, wherein the user interface includes a keypad.

6. A method of performing a transaction, the method comprising:
receiving a request for the transaction at a network client;
reading transaction data from a portable data repository using a reader, the reader including
a multi-bit data sensor configured to read the transaction data from a portable data repository, and
a logic circuit configured to modify the transaction data;
modifying all or part of the transaction data;
transmitting the modified transaction data from the network client to a merchant system;
transmitting the modified transaction data from the merchant system to a banking system;
verifying the transaction data using the banking system and consumer data stored therein; and
transmitting the verification from the banking system to the merchant system.

7. The method of claim 6, wherein the reader further includes a movement detector configured to receive directional input from a user.

8. The method of claim 6, wherein modifying all or part of the transaction data includes encryption using the logic circuit.

9. The method of claim 6, wherein modifying all or part of the transaction data includes substituting with a transaction code.

10. The method of claim 9, wherein the transaction code is a credit card code.

11. The method of claim 9, wherein the transaction code is generated by the reader.

12. The method of claim 9, wherein the transaction code is generated using a serial number of the reader.

13. The method of claim 9, further including acknowledging payment in the transaction using a communication from the banking system to the network client.

14. The method of claim 6, wherein verifying the transaction data includes using a serial number of the reader.

15. The method of claim 6, wherein the transaction code is generated using the banking system.

16. A method of performing a transaction, the method comprising:
receiving transaction data from a user;
transmitting the transaction data from the consumer terminal to a banking system, the banking system including a transaction system;
verifying the transaction data using the transaction system and consumer data stored therein;
generating a transaction code responsive to a result of the verification;
storing a copy of the transaction code in the transaction system;
transmitting the transaction code from the banking system to the consumer terminal;
transmitting the transaction code from the consumer terminal to a merchant system;
transmitting the transaction code from the merchant system to the banking system;
verifying the transaction using the transaction system, the transaction code received from the merchant system and the stored copy of the transaction code; and
transmitting the verification from the banking system to the merchant system.

17. The method of claim 16, wherein the transaction data includes credit card data or debit card data.

18. The method of claim 16, wherein the transaction code is configured to be used as a credit card data, as a debit card data, or as a checking account number, by the merchant system.

19. A method of controlling access to a device identity, the method comprising:
receiving a request for a device identity;
deciding to accept the request;
reading a portable data repository using a reader, the reader including
a) a multi-bit data sensor configured to read data from the portable data repository,
b) reader data stored in memory, and
c) a logic circuit configured to authorize output of a device identity, the authorization being responsive to a comparison of the reader data and the data read from the portable data repository;
authorizing output of the device identity using the logic circuit; and
outputting the device identity responsive to the authorization.

20. The method of claim 19, wherein the device identity is a processor identity.

21. The method of claim 19, wherein the reader further includes a movement detector configured to detect movement of the reader;

22. The method of claim 19, wherein the device identity is a serial number of the reader.

23. The method of claim 19, wherein the device identity is encrypted using the logic circuit.

24. A transaction system comprising:
a communication interface configured to receive encrypted transaction data through a network, the transaction data encrypted using a reader including
a multi-bit data sensor configured to read non-encrypted transaction data from a portable data repository, and
a logic circuit configured to generated the encrypted transaction data from the non-encrypted transaction data;
memory configured to store a decryption key configured for decrypting the encrypted transaction data; and
a server configured to decrypt the encrypted transaction data using the encryption key.

25. The transaction system of claim 24, wherein the transaction data is bank account data.

26. The transaction system of claim 24, wherein the server is further configured to select the decryption key using a serial number of the reader.

27. A manual data input device comprising:
a keypad configured for manual entry of non-encrypted data;
a serial number stored in memory and configured to identity the data input device;
a logic circuit configured to generate encrypted data using the non-encrypted data; and
a peripheral interface configured for communicating the encrypted data or the serial number, to a computing device.

28. The manual data input device of claim 27, further including an input configured to turn on or off the encryption of data using the logic circuit.

29. The manual data input device of claim 27, wherein the manual data input device is powered using the peripheral interface.

30. The manual data input device of claim 27, wherein the manual data input device is a computer peripheral.

31. A method of performing a transaction, the method comprising:
receiving a request for the transaction at a consumer terminal, the transaction including a transaction value;
reading transaction data from a portable data repository using a reader, the reader including a multi-bit data sensor configured to read the transaction data from a portable data repository;
transmitting the transaction data from the consumer terminal to a banking system, the banking system including a transaction system;
verifying the transaction data using the transaction system and consumer data stored therein;
generating a transaction code responsive to a result of the verification;
storing a copy of the transaction code in the transaction system;
transmitting the transaction code from the banking system to the consumer terminal;
transmitting the transaction code from the consumer terminal to a merchant system;
transmitting the transaction code from the merchant system to the banking system;
verifying the transaction using the transaction system, the transaction code received from the merchant system and the stored copy of the transaction code; and
transmitting the verification from the banking system to the merchant system.

32. The method of claim 31, wherein the reader further includes a movement detector configured to receive directional input from a user.

33. The method of claim 31, wherein the consumer terminal further includes a logic circuit configured to encrypt the transaction data.

34. The method of claim 33, further including encrypting all or part of the transaction data using the logic circuit, prior to transmitting the transaction data from the network client to a banking system, and decrypting the encrypted transaction information using the card present transaction system and reader data stored therein.

35. The method of claim 31, wherein decrypting the encrypted transaction information includes using a serial number of the reader.

36. The method of claim 31, wherein verifying the decrypted transaction data includes using a serial number of the reader.

37. A method of purchasing a product or service over a computer network, the method comprising:
selecting a product or service offered by a merchant;
reading data from a portable data repository using a reader;
automatically populating a data field with data, responsive to the read data; and
communicating the data populated, over the computer network to execute a secure transaction.

38. The method of claim 37, wherein the reader includes
a multi-bit data sensor configured to read the transaction data from a portable data repository, and
a serial number.

39. The method of claim 38 wherein the data read from the portable data repository includes credit card data.

40. The method of claim 38, wherein the reader further includes a movement detector configured to control a cursor.

41. The method of claim 38, wherein the serial number is used to execute the secure transaction.

42. The method of claim 37, further including modifying the read data using a logic circuit included in the reader.

43. The method of claim 37, wherein the data populated is communicated to a merchant or a banking system.

44. The method of claim 37, wherein the data populated includes an e-mail address.

45. The method of claim 37, wherein the read data includes an e-mail address.

46. The method of claim 37, wherein the data populated includes at least part of the data read from the portable data repository.

47. The method of claim 37, wherein the communication of the data populated over the computer network is automatic.

48. A method of performing a transaction, the method comprising:
receiving a request for the transaction at a network client;
receiving transaction data using a reader, the reader including
a user interface configured to receive transaction data from a user, and
a peripheral interface configured to transfer the transaction data from the reader;
modifying all or part of the transaction data;
transmitting the modified transaction data from the network client to a merchant system, the merchant system not having access to all or part of the unmodified transaction data;
transmitting the modified transaction data from the merchant system to a banking system;
